(19) United States
(12) Patent Application Publication
(10) Pub. No.: US 2014/0371069 A1
(43) Pub. Date: Dec. 18, 2014

(54) Short-Chain Alkyl Sulfonates in Pesticide Formulations and Applications

(71) Applicant: Akzo Nobel Chemicals International B.V., Amersfoort (NL)

(72) Inventor: Mark Alexander, Fort Worth, TX (US)

(21) Appl. No.: 14/361,354

(22) PCT Filed: Dec. 4, 2012
(86) PCT No.: PCT/EP2012/074296

§ 371 Date: May 29, 2014

Related U.S. Application Data
(60) Provisional application No. 61/567,702, filed on Dec. 7, 2011.

(30) Foreign Application Priority Data
Feb. 10, 2012 (EP) 12154811.9

(51) Int. Cl. A01N 25/22; A01N 57/20

(52) U.S. Cl. CPC A01N 25/22; A01N 57/20
USPC 504/127; 504/206

(57) ABSTRACT

The present invention relates to pesticide formulations containing at least one pesticide active, a hydrotrope comprising a short-chain alkyl sulfonate, and an adjuvant, wherein the weight ratio of the pesticide active to the adjuvant is from about 1:1 to about 1:5. The present invention also relates to herbicide formulations containing at least one herbicidal active comprising glufosinate-ammonium, a hydrotrope comprising sodium octane sulfonate, and an adjuvant comprising a sodium salt of C8 ether sulfate, wherein the weight ratio of the herbicide active to the adjuvant is about 1:1. The present invention also further relates to methods of providing pesticide protection to an agricultural crop by applying the pesticide formulations of the present invention to the crop.

### FIELD OF THE INVENTION

The present invention relates to the use of short-chain alkyl sulfonates as hydrotropes in pesticide formulations, more specifically in glufosinate-ammonium formulations, and applications of such formulations.

### BACKGROUND OF THE INVENTION

It is a challenging task for an agricultural chemical formulator to create products that balance bioefficacy, toxicity, cost, shelf life, and user friendliness. Of particular importance to the activity of an agricultural formulation is the ability of an aqueous solution to spread evenly over a surface, the so-called wetting ability, and the effective uptake of the active ingredient by the plant to be treated. For example, in agricultural formulations, efficacy benefits from a good wetting of the plant surface and uptake of the active ingredient.

To improve the activity of agricultural formulations, adjuvants are added thereto to reduce the amounts of active ingredients needed, thus lowering formulation cost. Adjuvants generally take the form of surface-active or salt-like compounds. Depending on their mode of action, adjuvants are classified as modifiers, actuators, fertilizers, and/or pH buffers.

Surfactants are generally regarded as modifiers and/or actuators as they improve wetting properties and uptake of the active ingredients in agricultural formulations. Additionally, some surfactants improve the solubility of active ingredients, thereby reduce certain stability issues such as product separation and/or crystallization.

Depending on the desired effect, different types of surfactants (e.g., anionic, cationic, amphoteric, and nonionic) are used in agricultural applications. For example, nonionic surfactants are known to be good wetting agents, and are often present in agricultural formulations. Many nonionic surfactants, however, are not soluble enough in solutions with a high amount of electrolytes, such as alkali and/or alkaline complexing agents, salts, and the like, and therefore need the presence of a hydrotrope, which is a compound that solubilises hydrophobic compounds in aqueous solutions, to improve the solubility. Examples of such a hydrotrope are ethanol, sodium xylene sulfonate, sodium cumene sulfonate, alkyl glycosides, and phosphated alkoxylated alcohols.

In addition, application culture has changed with farmers. In the past, pesticides and fertilizers were typically applied separately, but due to time constraints and fuel costs they are being combined and applied in one-tank mixes. The ionic strength of the fertilizer solution, however, leads to incompatibility issues due to a reduction in the solubility of the surfactants/adjuvants in the pesticide formulation. To overcome the incompatibility issues, a hydrotrope may be added to the combined fertilizer/pesticide formulation to modify the solubility properties within the pesticide formulation and/or to improve the mixing and dispersion of the pesticide formulation into the fertilizer solution. Examples of such a hydrotrope are sodium xylene sulfonate or phosphate esters.

As pesticide formulations become more complex and concentrated (e.g., pesticide formulations having an increased active loading, pesticide formulations containing a higher number of actives, or the inclusion of adjuvants (e.g., surfactants) to pesticide formulations), the amount of water used in the formulations is reduced which leads to solubility issues within the formulations. A specific example is a formulation containing glufosinate-ammonium. Glufosinate-ammonium is a water soluble, phosphinic acid based herbicide used for broad spectrum weed control. Early uses of the herbicide were for non-selective applications but tolerant crops have been engineered so applications now include food crops. The adjuvant used in combination with glufosinate-ammonium is typically an alcohol ether sulfate which is neutralized to form a sodium salt but the ammonium salt can also be used, and the adjuvant is formulated in-can with the herbicide. The weight ratio of pesticide to adjuvant can range from about 1:1 to about 1:5. As the ratio of pesticide to adjuvant moves closer to 1:1, however, the compatibility of the adjuvant becomes more challenging.

In addition, the compatibility is dependent on the concentration of the active ingredient in the final formulation. As the concentration of the active ingredient increases, the amount of water in the final formulation decreases causing difficulties in developing a formulation that is storage stable, i.e., a formulation that does not separate upon storage. In a formulation where the amount of water is low, generally known hydrotropes either fail to provide the desired stability or do not provide an acceptable level of stability.

WO 02/21916 (“WO '916”) relates to an antimicrobial composition containing a quaternary ammonium antimicrobial compound, an anionic surfactant, and a bridging surfactant. WO '916 merely mentions that the surfactant blend according thereto may be employed as a surfactant in agricultural and pesticide applications; however, WO '916 does not recognize the incompatibility that may result when the weight ratio of pesticide to adjuvant is in the range of about 1:1 to about 1:5. WO 2011/036152 (“WO '152”) relates to a pesticide formulation containing a monoalkyl sulfosuccinate as a hydrotrope. WO '152 does not teach or suggest short chain alkyl sulfonates as a hydrotrope; one of ordinary skill in the art readily recognizes that the two are different classes of surfactants and the performance of one cannot be used to predict the performance of the other.

Accordingly, the object of the present invention is to find an effective agricultural hydrotrope that may be used in pesticide formulations that results in stable pesticide formulations with improved activity.

### SUMMARY OF THE INVENTION

The present invention is directed to a stable pesticide formulation comprising: a pesticide active; a short-chain alkyl sulfonate hydrotrope; and an adjuvant. The weight ratio of the pesticide active to the adjuvant is from about 1:1 to about 1:5. In one embodiment, the stable pesticide formulation comprises: glufosinate-ammonium; sodium octane sulfonate as a hydrotrope; and sodium salt of C8 ether sulfate as an adjuvant, wherein the weight ratio of the glufosinate ammonium to the ether sulfate is about 1. The octane sulfonate or octyl sulfonate need not be limited to an inorganic salt, such as sodium or potassium; other salts can be readily employed, including but not limited to amine salts. Examples of organic amines employable include, but are not limited to isopropylamine, dimethylamine, butylamine, monoethanolamine, diethanolamine, triethanolamine, dimethylaminopropylamine (DMAPA), diethylenetriamine (DETA), triisopropylamine, methoxypropylamine, dimethylethanolamine, diethylethanolamine, choline and combinations and mixtures thereof.

The present invention is also directed to a method of providing pesticide protection to an agricultural crop. The method comprises applying the pesticide formulations of the present invention.

### BRIEF DESCRIPTION OF THE DRAWINGS

FIG. 1 is a ternary diagram showing regions of varying percentages of separation after 24 hours at room temperature of aqueous mixtures comprising pesticide active, adjuvant, and sodium octane sulfonate as hydrotrope.

FIG. 2 is a ternary diagram showing regions of varying percentages of separation after one freeze/thaw cycle of aqueous mixtures comprising pesticide active, adjuvant, and sodium octane sulfonate as hydrotrope.

FIG. 3 is a ternary diagram showing regions of varying percentages of separation after two hours at room temperature of aqueous mixtures comprising pesticide active, adjuvant, and sodium xylene sulfonate as hydrotrope.

FIG. 4 is a ternary diagram showing regions of varying percentages of separation after one freeze/thaw cycle of aqueous mixtures comprising pesticide active, adjuvant, and sodium xylene sulfonate as hydrotrope.

### DETAILED DESCRIPTION OF THE INVENTION

As noted above, as the weight ratio of the pesticide active to the adjuvant moves closer to 1:1, the compatibility of the adjuvant becomes more challenging which results in the separation of the components. The present inventor has performed extensive research and has found that generally known hydrotropes either fail to provide the desired stability or do not provide an acceptable level of stability in a pesticide formulation containing a pesticide active and an adjuvant at a weight ratio of 1:1. Specifically, the pesticide active in the pesticide formulation is glufosinate-ammonium and the adjuvant is C8 ether sulfate.

The following hydrotropes were tested in a pesticide formulation containing glufosinate-ammonium and a C8 ether sulfate at a 1:1 weight ratio and they either failed to provide the desired stability or did not result in an acceptable level of stability of the formulation: dipropylene glycol monomethyl ether; propylene glycol; alkyl ethoxy quats (ethoxylated cocoamine quarternary ammonium chlorides (Ethoquad® C/12-75 and Ethoquad® C/25)); alkyl quats (cocamine quarternary ammonium chlorides (Arquad® 12/37W), octyl quarternary ammonium chloride (Arquad® L8-70)); alkyl ethoxy phosphate esters (C12/15 alcohol+3EO phosphate ester, acid form (Phospholan® PS 222), C6 alcohol+6EO, phosphate ester, potassium salt (Berol® 725SA)); alkyl phosphate esters (C6-10 alcohol phosphate ester (Phospholan® PS 400)); alkyl ether sulfates (C4 alcohol+2EO sulfate ester sodium salt; C6 alcohol+4EO sodium salt; C4 alcohol+4EO sulfate esters sodium salt); polyacrylates (Alcosperse® 747 and 729); alkyl sulfates (sodium lauryl sulfate (Witcolate® WAC-LA), 2-ethylhexyl sulfate (Standapol® EHS)); alkyl glucosides (AG 6202, 6202, 6210); fatty amine ethoxylates (cocoamines+5EO and 15EO (Ethomeen® C15, C25), tallowamine+14EO (Witconate® T24H)); fatty amides (coco APA (Adsee® C80W); C10 fatty acid dimethyl amide (Armid® DM10); C2, C5, C6, C8, and C9 APAs); betaines (cocoamphopolycarboxyglycinate (Amphoteen® 24, Ampholak® 7CY/C), octyliminodipropionate (Ampholak® YJH-40)); and alkyl aryl sulfonates (sodium cumene sulfonate, sodium xylene sulfonate, C12 benzene sulfonate sodium salt (Witconate 90)). Each of the pesticide formulations containing the above-mentioned materials developed two phases that separated very quickly. It is an indication that each of the above-mentioned materials tested as a hydrotrope did not function as a hydrotrope in the pesticide formulation.

Surprisingly, however, short-chain alkyl sulfonates were found to be effective as hydrotropes in the pesticide formulations resulting in stable formulations. Accordingly, the present invention is directed to a pesticide formulation comprising a pesticide active; a short-chain alkyl sulfonate hydrotrope; and an adjuvant, wherein the weight ratio of the pesticide active to the adjuvant is from about 1:1 to about 1:5.

Examples of adjuvants that may be used in the pesticide formulation of the present invention include, but are not limited to, alcohol alkoxylates, fatty amine alkoxylates, fatty acid esters, fatty acid aminde, methyl ester alkoxylates, alcohol ether phosphates, alcohol ether sulfates, betaines, alkyl quarternary amines, and ethoxylated alkyl quarternary amines. In one embodiment, the adjuvant is a sodium or ammonium salt of an alcohol ether sulfate. Examples of an alcohol ether sulfate include, but are not limited to, C6 alcohol ether sulfate, C7 alcohol ether sulfate, C8 alcohol ether sulfate, lauryl ether sulfate and combinations and/or mixtures thereof. In one embodiment, the adjuvant is C8 alcohol ether sulfate. In another embodiment, the adjuvant is a sodium salt of C8 alcohol ether sulfate.

In one embodiment, the weight ratio of the pesticide active to the adjuvant is from about 1:1 to about 1:5. In another embodiment, the ratio is from about 1:1 to about 1:3. In yet another embodiment, the ratio is about 1:2, and in even yet another embodiment, the ratio is about 1:1.

The short-chain alkyl sulfonate hydrotrope in the pesticide formulation of the present invention may be a short chain, i.e., a C1-C10 alkyl sulfonate. Examples of alkyl sulfonates that may be used in the pesticide formulation of the present invention include, but are not limited to, sodium butane sulfonate, sodium pentane sulfonate, sodium hexane sulfonate, sodium octane sulfonate, and sodium decane sulfonate. In one embodiment, the alkyl sulfonates are linear. The short-chain alkyl sulfonate hydrotrope may also include olefin sulfonates (C2-C10). In one embodiment, the olefin sulfonates are linear. In another embodiment, the olefin sulfonates are alpha olefin sulfonates. In a preferred embodiment, the hydrotrope is sodium octyl sulfonate as shown below.

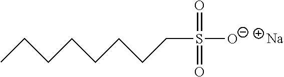

The short-chain alkyl sulfonate hydrotrope may be present in the pesticide formulation of the present invention in an effective amount, i.e., in an amount from about 0.1% to about 20%, in another embodiment from about 2.5% to about 15%, and in still another embodiment from about 7.5% to about 12.5% by weight of the formulation.

The pesticide ingredient or active is a herbicide active, a fungicide active, an insecticide active, or combinations and/or mixtures thereof.

In one embodiment, the pesticide active is a fungicide active. Examples of the fungicide active that may be used in the present pesticide formulation include, but are not limited to, acibenzolar-S-methyl, aldimorph, amisulbrom, anilazine, azaconazole, azoxystrobin, benalaxyl, benodanil, benomyl, benthiavalicarb, binapacryl, biphenyl, bitertanol, blasticidin-S, boscalid, bromuconazole, bupirimate, captafol, captan, carbendazim, carboxin, carpropamid, chloroneb, chlorothalonil, chlozolinate, copper, cyazofamid, cyflufenamid, cymoxanil, cyproconazole, cyprodinil, dichlofluanid, diclocymet, diclomezine, dicloran, diethofencarb, difenoconazole, diflumetorim, dimethirimol, dimethomorph, dimoxystrobin, diniconazole, dinocap, dithianon, dodemorph, dodine, edifenphos, enestrobin, epoxiconazole, etaconazole, ethaboxam, ethirimol, etridiazole, famoxadone, fenamidone, fenarimol, fenbuconazole, fenfuram, fenhexamid, fenoxanil, fenpiclonil, fenpropidin, fenpropimorph, fentin acetate, fentin chloride, fentin hydroxide, ferbam, ferimzone, fluazinam, fludioxonil, flumorph, fluopicolide, fluoxastrobin, fluquinconazole, flusilazole, flusulfamide, flutolanil, flutriafol, folpet, fosetyl-Al, fthalide, fuberidazole, furalaxyl, furametpyr, guazatine, hexaconazole, hymexazole, imazalil, imibenconazole, iminoctadine, iodocarb, ipconazole, iprobenfos (IBP), iprodione, iprovalicarb, isoprothiolane, isotianil, kasugamycin, kresoxim-methyl, laminarin, mancozeb, mandipropamid, maneb, mepanipyrim, mepronil, meptyldinocap, metalaxyl, metalaxyl-M, metconazole, methasulfocarb, metiram, metominostrobin, metrafenone, mineral oils, organic oils, myclobutanil, naftifine, nuarimol, octhilinone, ofurace, origin, orysastrobin, oxadixyl, oxolinic acid, oxpoconazole, oxycarboxin, oxytetracycline, pefurazoate, penconazole, pencycuron, penthiopyrad, phophorous acid, picoxystrobin, piperalin, polyoxin, potassium bicarbonate, probenazole, prochloraz, procymidone, propamocarb, propiconazole, propineb, proquinazid, prothiocarb, prothioconazole, pyraclostrobin, pyrazophos, pyribencarb, pyributicarb, pyrifenox, pyrimethanil, pyroquilon, quinoxyfen, quintozene (PCNB), salts, silthiofam, simeconazole, spiroxamine, streptomycin, sulphur, tebuconazole, teclofthalam, tecnazene (TCNB), terbinafine, tetraconazole, thiabendazole, thifluzamide, thiophanate, thiophanate-methyl, thiram, tiadinil, tolclofosmethyl, tolylfluanid, triadimefon, triadimenol, triazoxide, tricyclazole, tridemorph, trifloxystrobin, triflumizole, triforine, triticonazole, validamycin, valiphenal, vinclozolin, zineb, ziram, zoxamide, and mixtures thereof.

In another embodiment, the pesticide active is an insecticide active. Examples of the insecticide active that may be used in the present pesticide formulation include, but are not limited to, kerosene or borax, botanicals or natural organic compounds (e.g., nicotine, pyrethrin, strychnine, and rotenone), chlorinated hydrocarbon (e.g., DDT, lindane, and chlordane), organophosphates (e.g., malathion and diazinon), carbamates (e.g., carbaryl and propoxur), fumigants (e.g., naphthalene), benzene (e.g., mothballs), synthetic pyrethroids, and mixtures thereof.

In another embodiment, the pesticide active is a herbicide active. Examples of the herbicide active that may be used in the present pesticide formulation include, but are not limited to, acetochlor, acifluorfen, aclonifen, alachlor, ametryn, amidosulfuron, aminopyralid, amitrole, anilofos, asulam, atrazine, azafenidin, azimsulfuron, benazolin, benfluralin, bensulfuron-methyl, bentazone, bifenox, binalafos, bispyribac-sodium, bromacil, bromoxynil, butachlor, butroxidim, cafenstrole, carbetamide, carfentrazone-ethyl, chloridazon, chlorimuron-ethyl, chlorobromuron, chlorotoluron, chlorsulfuron, cinidon-ethyl, cinosulfuron, clethodim, clomazone, clopyralid, cloransulam-methyl, clorsulfuron, cyanazine, cycloate, cyclosulfamuron, cycloxydim, dalapon, desmedipham, dicamba, dichlobenil, dichlormid, diclosulam, diflufenican, dimefuron, dimepipeate, dimethachlor, dimethenamid, diquat, diuron, esprocarb, ethalfluralin, ethametsulfuron-methyl, ethofumesate, ethoxysulfuron, fentrazamide, flazasulfuron, florasulam, fluchloralin, flufenacet, flumetsulam, flumioxazin, fluometuron, flupyrsulfuron-methyl, flurochloridone, fluroxypyr, flurtamone, fomesafen, foramsulfuron, glufosinate, hexazinone, imazamethabenz-M, imazamox, imazapic, imazapyr, imazaquin, imazethapyr, imazosulfuron, iodosulfuron, ioxynil, isoproturon, isoxaben, isoxaflutole, lactofen, lenacil, linuron, mefenacet, mesosulfuron-methyl, mesotrione, metamitron, metazachlor, methabenzthiazuron, metobromuron, metolachlor, metosulam, metoxuron, metribuzin, metsulfuron-methyl, molinate, MSMA, napropamide, nicosulfuron, norflurazon, oryzalin, oxadiargyl, oxadiazon, oxasulfuron, oxyfluorfen, paraquat, pendimethalin, phenmedipham, picloram, pretilachlor, profoxydim, prometryn, propanil, propisochlor, propoxycarbazone, propyzamide, prosulfocarb, prosulfuron, pyraflufen-ethyl, pyrazosulfuron, pyridate, pyrithiobac, quinclorac, quinmerac, rimsulfuron, sethoxydim, simazine, s-metolachlor, sulcotrione, sulfentrazone, sulfosulfuron, tebuthiuron, tepraloxydim, terbuthylazine, terbutryn, thifensulfuron-methyl, thiobencarb, tralkoxydim, triallate, triasulfuron, tribenuron-methyl, triclopyr, trifloxysulfuron, trifluralin, triflusulfuron-methyl, tritosulfuron, and mixtures thereof.

When the herbicide is an acid, it can be used in the acid form, though it is preferred that the herbicide be in the salt form selected from the group consisting of amine, lithium, sodium, ammonium, and potassium salts. It should be noted that when a pesticide appears in the specification as a general name without the counterions, it means both its acid form and salt form. In one embodiment, the herbicide active is glufosinate-ammonium.

Other additives may be present in the pesticide formulation of the present invention. Such additives may be defoamers, diluents, compatibility agents, biocides, thickeners, drift control agents, dyes, fragrances, chelating agents, or mixtures thereof.

The present invention is also directed to a method of providing pesticide protection to an agricultural crop. The method comprises applying the pesticide formulation of the present invention to the crop.

The temperature range during application of the pesticide formulation of the present invention may vary based on the crop and geographical region. In addition, the degree of application of the pesticide formulation of the present invention may vary depending on the crop and the pesticide active in the formulation.

The present invention will be further described in the following non-limiting examples.

### Example 1

A design experiment was performed in which pesticide formulations containing the following were prepared:

| Component | Amount (% w/w) |
|---|---|
| Glufosinate ammonium, 95% | 25.8 |
| C8 ether sulfate (adjuvant), 80% | 30.6 |
| Sodium octane sulfonate (hydrotrope) | 0-10 |
| Propylene glycol | 0-15 |
| Water | q.s. to 100 |

Propylene glycol was necessary as the concentration of the hydrotrope was reduced.

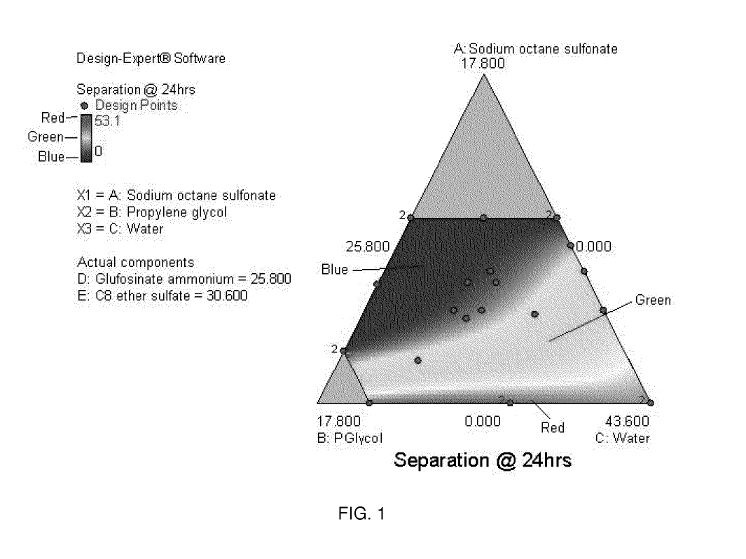

The formulations were allowed to sit for 24 hours at room temperature and the stability of the formulations was assessed. FIG. 1 illustrates the results of the experiment. FIG. 1 is a ternary diagram showing regions of varying percentages of separation after 24 hours at room temperature of the formulations containing the above-listed components.

The numbers associated with the small colored bar in the upper left hand corner of the figure indicate the percentage of separation in the samples. The colors in the bar correspond to the colored regions in the ternary diagram. As the regions in the graph go from red to blue the percentage of separation goes to zero (i.e., less separation and more stable).

As can be seen from the diagram, the blue region (i.e., the region of stability) in the diagram is large; therefore it is apparent that sodium octane sulfonate is effective as a hydrotrope in the formulations.

### Example 2

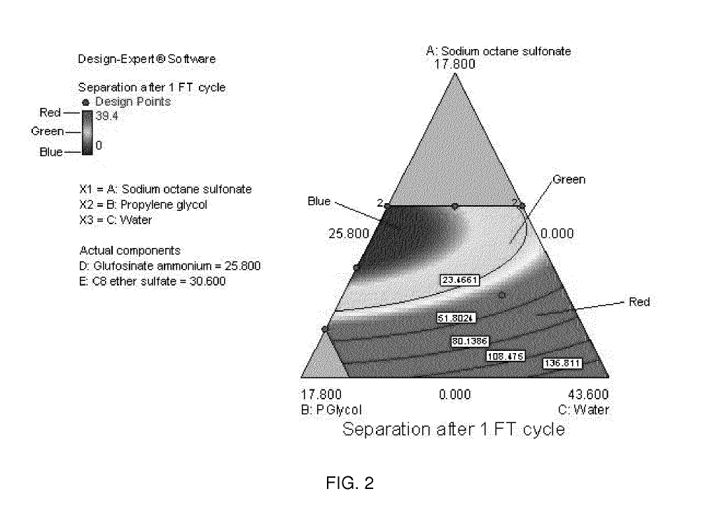

The formulations listed in Example 1 were subjected to a freeze/thaw cycle in which the formulations were frozen and thawed to room temperature. The stability of the formulations was then assessed. FIG. 2 illustrates the results of the assessment. FIG. 2 is a ternary diagram showing regions of varying percentages of separation after one freeze/thaw cycle of the formulations.

A freeze/thaw cycle changes the solubility of some of the components, therefore, by subjecting the formulations to a freeze/thaw cycle, the effect of the solubility change on the stability of the formulations can be assessed.

### Comparative Example 1

An experiment was performed in which pesticide formulations containing the following were prepared:

| Component | Amount (% w/w) |
|---|---|
| Glufosinate ammonium, 95% | 25.8 |
| C8 ether sulfate (adjuvant), 80% | 30.6 |
| Sodium xylene sulfonate (hydrotrope) | 0-10 |
| Propylene glycol | 0-15 |
| Water | q.s. to 100 |

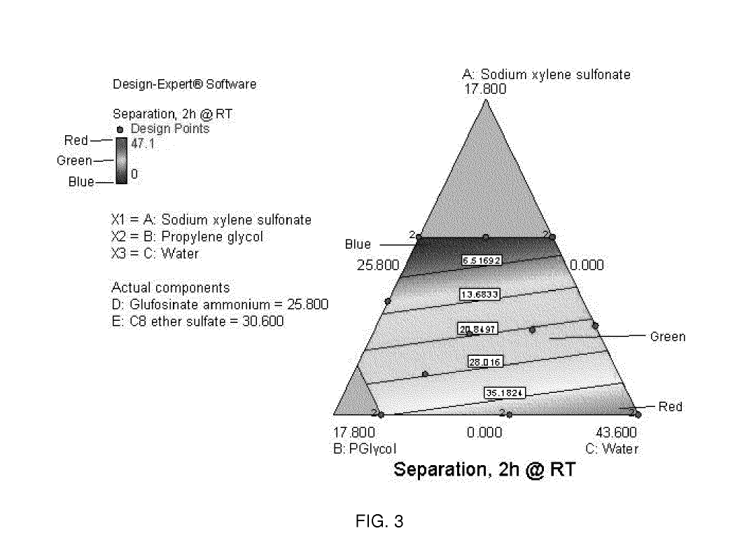

The formulations were allowed to sit for two hours at room temperature and the stability of the formulations was assessed. FIG. 3 illustrates the results of the experiment. FIG. 3 is a ternary diagram showing regions of varying percentages of separation after two hours at room temperature of the formulations containing the above-listed components.

As can be seen from the diagram, the region of stability (the blue region) was small after only two hours at room temperature. Comparing the diagram of the formulation containing sodium octane sulfonate in FIG. 1 with the diagram of the formulation containing sodium xylene sulfonate in FIG. 3, it is clear that the blue region in the diagram in FIG. 1 is significantly larger than that in the diagram in FIG. 3, indicating that sodium octane sulfonate is significantly more effective as a hydrotrope than sodium xylene sulfonate.

### Comparative Example 2

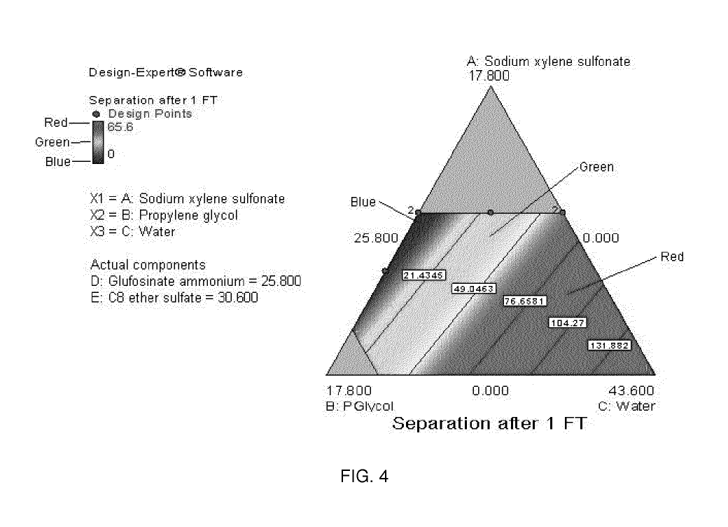

The formulations listed in Comparative Example 1 were subjected to a freeze/thaw cycle and the stability of the formulations was subsequently assessed. FIG. 4 illustrates the results of the assessment. FIG. 4 is a ternary diagram showing regions of varying percentages of separation after one freeze/thaw cycle of the formulations.

Comparing the diagram in FIG. 4 with the diagram in FIG. 2 (of the formulation containing sodium octane sulfonate), it is again clear that the region of stability (the blue region) in the diagram in FIG. 2 is larger than that in the diagram in FIG. 4, indicating that sodium octane sulfonate is more effective as a hydrotrope than sodium xylene sulfonate.

1. A herbicide formulation comprising:
at least one herbicide active;
a hydrotrope comprising a C1-C10 alkyl sulfonate; and
an adjuvant,
wherein the weight ratio of the herbicide active to the adjuvant is from about 1:1 to about 1:5.

2. (canceled)

3. The herbicide formulation of claim 1, wherein the herbicide is glufosinate-ammonium.

4. The herbicide formulation of claim 1, wherein the alkyl sulfonate hydrotrope is present in the amount of about 0.1% to about 20% by weight of the pesticide formulation.

5. The herbicide formulation according to claim 1, wherein the C1-C10 alkyl sulfonate is sodium octane sulfonate.

6. The herbicide formulation of claim 1, wherein the adjuvant comprises a sodium or ammonium salt of an alcohol ether sulfate.

7. The herbicide formulation of claim 6, wherein the sodium or ammonium salt of an alcohol ether sulfate is sodium salt of a C8 alcohol ether sulfate.

8. The herbicide formulation according to claim 1, wherein the weight ratio of the pesticide active to the adjuvant is about 1:1.

9. A herbicide formulation comprising:
at least one herbicide active comprising glufosinate-ammonium;
a hydrotrope comprising sodium octane sulfonate; and
an adjuvant comprising a sodium salt of a C8 ether sulfate,
wherein the weight ratio of the herbicide active to the adjuvant is about 1:1.

10. The formulation of claim 9 comprising at least one co-herbicide.

11. A method of providing herbicidal protection to an agricultural crop, the method comprising applying to the crop an effective amount of the formulation of claim 1.

12. A method of providing herbicidal protection to an agricultural crop, the method comprising applying to the crop an effective amount of the herbicide formulation of claim 9.
